(19) United States
(12) Patent Application Publication
(10) Pub. No.: US 2021/0220917 A1
(43) Pub. Date: Jul. 22, 2021

(54) RIM TRIMMING MACHINE

(71) Applicant: TOP-ONE MACHINERY CO., LTD., Taichung City (TW)

(72) Inventor: Tsui-O LIU, Taichung City (TW)

(21) Appl. No.: 16/744,335

(22) Filed: Jan. 16, 2020

(51) Int. Cl. B23B 27/04

(52) U.S. Cl. CPC B23B 27/04; B23B 2215/08

(57) ABSTRACT

A rim trimming machine comprises a mounting rack, a first axial moving device, a second axial moving device, a cutter turret, a base, and a chuck. The mounting rack is a board and is disposed vertically. The first axial moving device is mounted to the mounting rack and has a first axial sliding stand being movable along a first moving direction. The second axial moving device is mounted to the first axial sliding stand and has a second axial sliding stand being movable along a second moving direction. The cutter turret is mounted to the second axial moving device and has a cutter. The base is spaced apart from the mounting rack. The chuck is mounted on the base and has multiple jaws, each jaw having a radius. The cutter is above the chuck, and is aligned to a position between two ends of one of the jaws.

### BACKGROUND OF THE INVENTION

### 1. Field of the Invention

The present invention relates to a rim trimming machine, and more particularly to a rim trimming machine being light-weighted and space-saving, being convenient in transport, and having better practicality.

### 2. Description of Related Art

With reference to FIG. 7, a conventional rim trimming machine includes a base 91, a horizontal moving device 92, a vertical moving device 93, a cutter turret 94, a mounting base 95, a chuck 96, and a motor 97. The base 91 is a block, is heavy and large, and has a mounting surface 911 disposed horizontally. The horizontal moving device 92 is mounted on the mounting surface 911 of the base 91 and is movable along a horizontal direction relative to the base 91. The vertical moving device 93 is mounted to a side surface of the horizontal moving device 92 and is movable along a vertical direction relative to the horizontal moving device 92. The cutter turret 94 is mounted to a side surface of the vertical moving device 93 away from the horizontal moving device 92 and has a cutter 941. The mounting base 95 is fixed on a side surface of the base 91, and is located below the cutter turret 94. The chuck 96 is mounted on the mounting base 95 and is utilized to clamp a rim. The cutter 941 of the cutter turret 94 is located above an outer edge of the chuck 96. The motor 97 is disposed on the mounting base 95, and is electrically connected to the chuck 96 so as to drive the chuck 96 to rotate relative to the mounting base 95. To trim the rim, adjust a position of the cutter turret 94 relative to the chuck 96 by controlling the horizontal moving device 92 and the vertical moving device 93.

However, the conventional rim trimming machine has the following drawbacks:
1. Since the base 91 is heavy and large, the base 91 drastically increases weight and volume of the conventional rim trimming machine. Thus the conventional rim trimming machine is hard to be moved to any location of the client in need of service but can only be installed in a factory. The client can only bring the rim in need of trimming to the factory to have the rim trimmed. Service quality is unable to be enhanced.
2. The chuck 96 is mounted on the mounting base 95, and the mounting base 95 is fixed on the side surface of the base 91, such that an unchangeable distance is formed between the chuck 96 and the cutter turret 94. Moreover, the cutter 941 of the cutter turret 94 is located above the outer edge of the chuck 96, so the cutter 941 can only trim the outer periphery of the rim or trim the rim corresponding to the chuck 96 in radius. The rim with smaller radius than the chuck 96 cannot be trimmed.

To overcome the shortcomings of the conventional rim trimming machine, the present invention tends to provide a rim trimming machine to mitigate or obviate the aforementioned problems.

### SUMMARY OF THE INVENTION

The main objective of the present invention is to provide a rim trimming machine.

The rim trimming machine comprises a mounting rack, a first axial moving device, a second axial moving device, a cutter turret, a base, and a chuck. The mounting rack is a board, is disposed vertically, and has a mounting surface forming an angle with a horizontal surface. The first axial moving device is mounted to the mounting surface of the mounting rack and has a first axial sliding stand. The first axial sliding stand is movable along a first moving direction relative to the mounting rack. The second axial moving device is mounted to the first axial sliding stand of the first axial moving device and has a second axial sliding stand. The second axial sliding stand is movable along a second moving direction relative to the first axial moving device. The cutter turret is mounted to a surface of the second axial moving device away from the first axial moving device and has a cutter. The base is spaced apart from the mounting rack such that a distance between the base and the mounting rack is adjustable, and the base is on a side of the mounting rack at which the first axial moving device is located. The chuck is mounted on the base and has multiple jaws. The multiple jaws are arranged annularly and are disposed at spaced intervals, and each one of the multiple jaws has a radius. The cutter of the cutter turret is above the chuck, and is aligned to a position between two ends of one of the multiple jaws.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rim trimming machine in accordance with the present invention;

FIG. 2 is a cross sectional side view in partial section of the rim trimming machine in FIG. 1;

FIG. 3 is an enlarged perspective view of the rim trimming machine in FIG. 1;

FIG. 4 is an enlarged exploded perspective view of the rim trimming machine in FIG. 1;

FIG. 5 is an operational front side view of the rim trimming machine in FIG. 1;

FIG. 6 is another operational front side view of the rim trimming machine in FIG. 1; and

FIG. 7 is a perspective view of a rim trimming machine in accordance with the prior art.

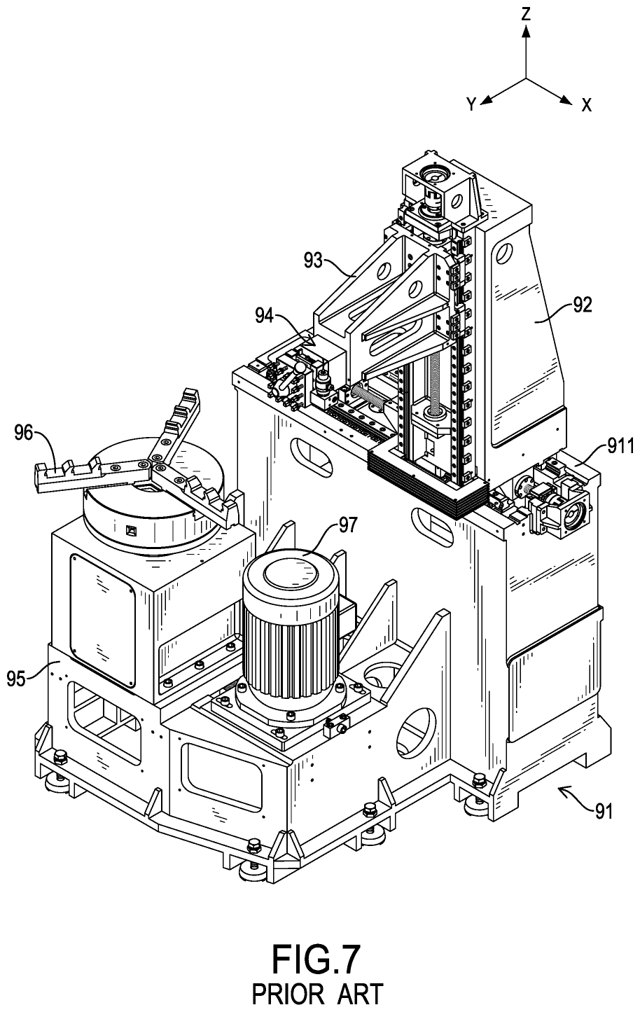

### DETAILED DESCRIPTION OF THE PREFERRED EMBODIMENT

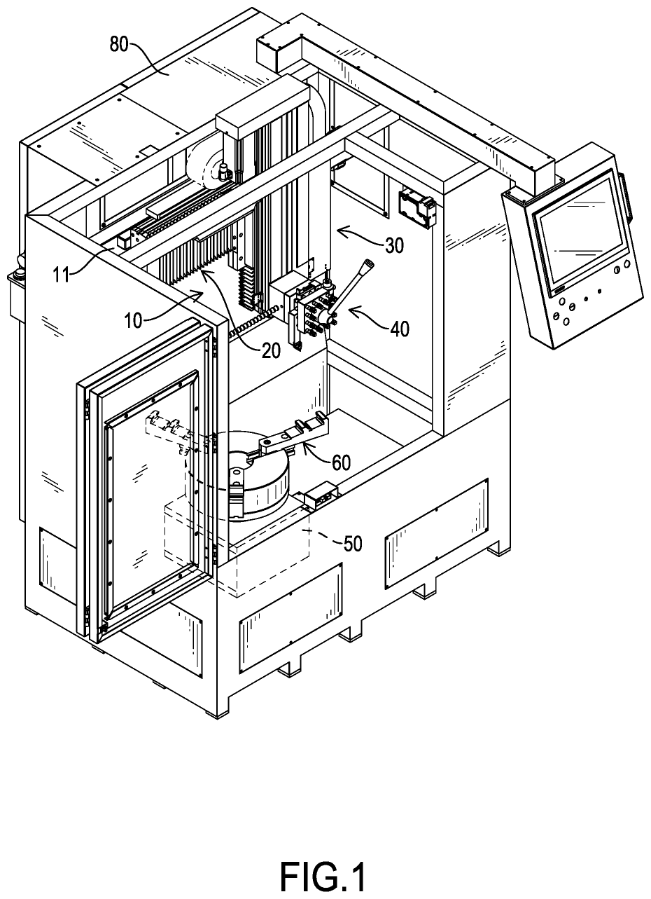

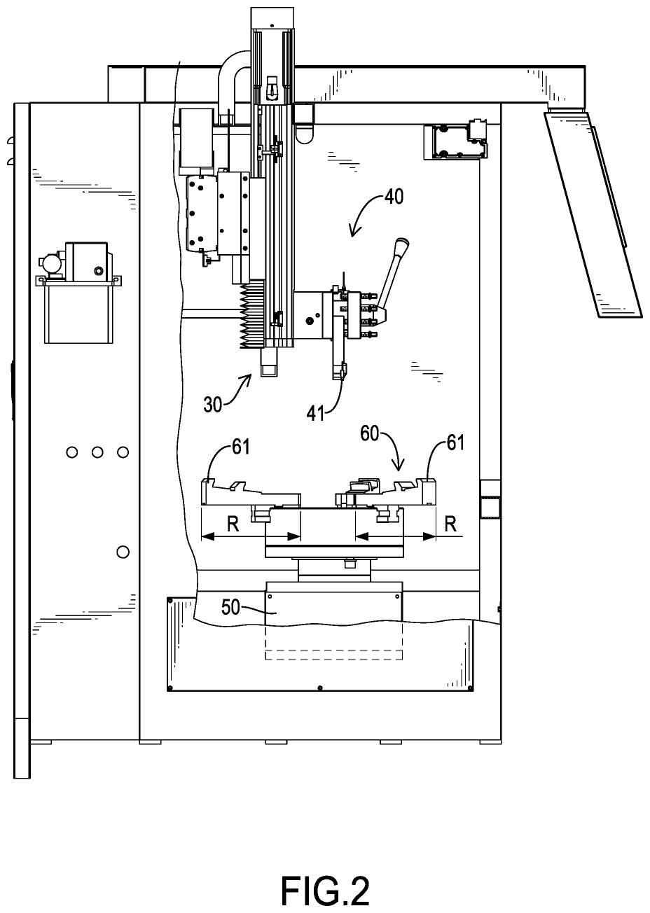

With reference to FIGS. 1 and 2, a rim trimming machine in accordance with the present invention includes a mounting rack 10, a first axial moving device 20, a second axial moving device 30, a cutter turret 40, a base 50, and a chuck 60.

With reference to FIG. 1, the mounting rack 10 is a board, is vertically disposed, and has a mounting surface 11 that forms an angle with a horizontal surface. In the present invention, the angle is a right angle. In other words, the mounting surface 11 is vertically disposed.

With reference to FIGS. 1, 3, and 4, the first axial moving device 20 is mounted to the mounting surface 11 of the mounting rack 10, and has a first axial slide table 21, two first axial guide rails 22, multiple first axial guide carriages 23, a first axial threaded rod 25, a first axial sliding stand 26, and a first axial actuator 24. The first axial slide table 21 is mounted to the mounting surface 11 of the mounting rack 10. Each one of the two first axial guide rails 22 is mounted between two ends of the first axial slide table 21, is parallel to a first moving direction, is spaced apart from the other one of the two first axial guide rails 22, and is parallel to the other one of the two first axial guide rails 22. Each one of the multiple first axial guide carriages 23 is mounted on one of the two first axial guide rails 22, and is capable of moving along the first moving direction relative to the corresponding first axial guide rail 22.

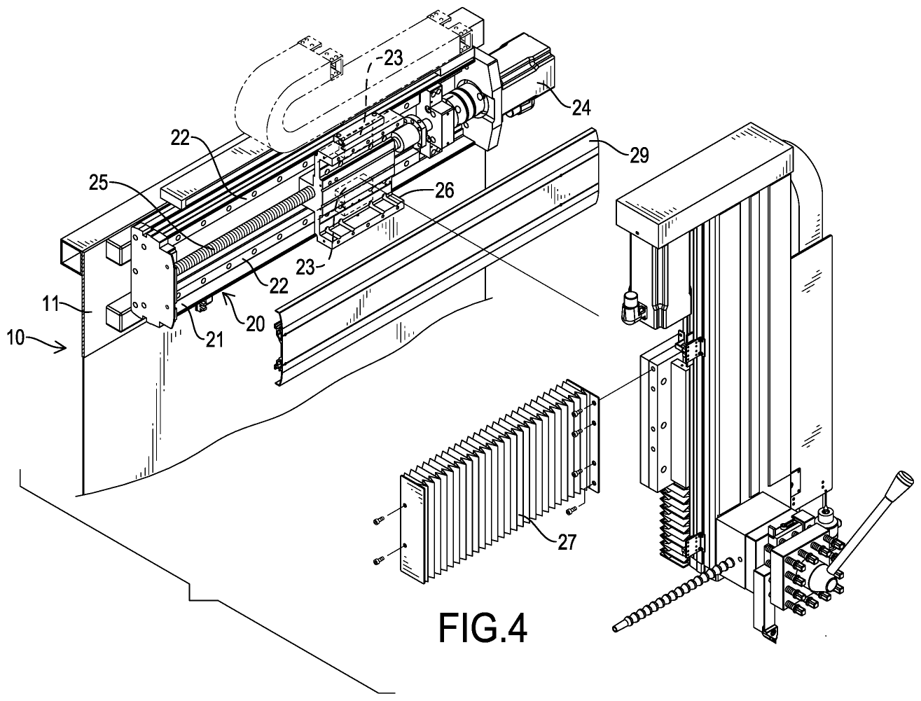

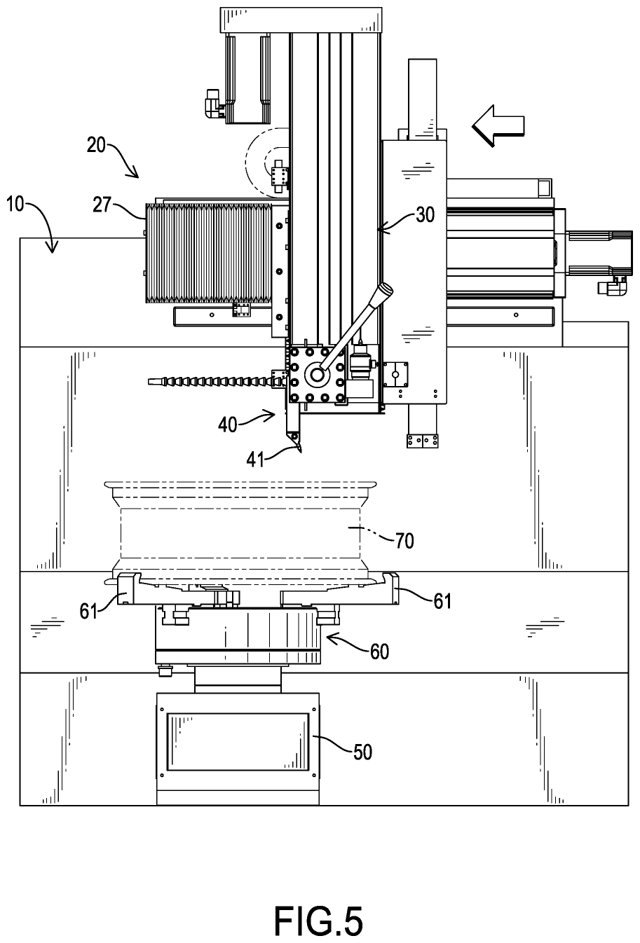

With reference to FIG. 4, the first axial threaded rod 25 is rotatably mounted between the two ends of the first axial slide table 21, is located between the two first axial guide rails 22, and is parallel to the first moving direction. The first axial sliding stand 26 is movably connected to the first axial threaded rod 25 to move along the first moving direction, and has a surface facing the first axial slide table 21 and mounted to the multiple first axial guide carriages 23. The first axial actuator 24 is mounted on an outer side surface of the first axial slide table 21, and one end of the first axial threaded rod 25 is extended into and is mounted to the first axial actuator 24 such that the first axial actuator 24 actuates the first axial threaded rod 25 to rotate. Driven by the first axial threaded rod 25, the first axial sliding stand 26 itself moves along the first moving direction and also drives the multiple first axial guide carriages 23 to move along the first moving direction relative to the corresponding first axial guide rail 22 as shown in FIGS. 4 and 5.

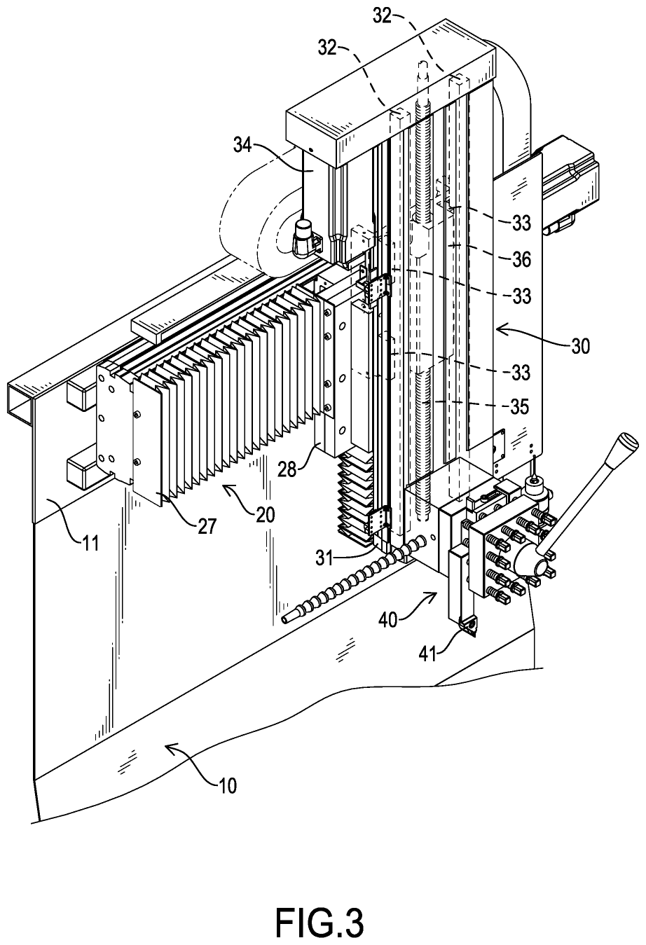

In the present invention, the first moving direction is a horizontal direction, so the first axial sliding stand 26 and the multiple first axial guide carriages 23 move along the horizontal direction. With reference to FIGS. 3 and 4, the first axial moving device 20 has a cover 29 and at least one connecting board 28. The cover 29 is mounted to a side of the first axial slide table 21 away from the mounting surface 11 of the mounting rack 10. The first axial sliding stand 26 has two mounting ends disposed away from one another, and the two mounting ends extend above a top side of the cover 29 and below a bottom side of the cover 29, respectively. The at least one connecting board 28 is mounted to the two mounting ends of the first axial sliding stand 26.

Furthermore, with reference to FIGS. 3 and 4, the first axial moving device 20 has a first axial bellow 27 sleeving the cover 29 and having two ends. One of the two ends of the first axial bellow 27 is mounted on a side surface of the at least one connecting board 28 away from the first axial actuator 24, and the other one of the two ends of the first axial bellow 27 is mounted to one of the two ends of the first axial slide table 21 away from the first axial actuator 24. When the first axial sliding stand 26 moves to a left side as shown in FIG. 5, the first axial bellow 27 is compressed. The first axial sliding stand 26 prevents dust or any objects from falling into the first axial moving device 20, which ensures that the first axial sliding stand 26 moves smoothly.

With reference to FIGS. 1 to 3, the second axial moving device 30 is mounted to the two mounting ends of the first axial sliding stand 26 of the first axial moving device 20 via the at least one connecting board 28. The second axial moving device 30 has a second axial slide table 31, two second axial guide rails 32, multiple second axial guide carriages 33, a second axial threaded rod 35, a second axial sliding stand 36, and a second axial actuator 34. The second axial slide table 31 is mounted to the first axial sliding stand 26 of the first axial moving device 20 via the at least one connecting board 28. Each one of the two second axial guide rails 32 is mounted between two ends of the second axial slide table 31, is parallel to a second moving direction, is spaced apart from the other one of the two second axial guide rails 32, and is parallel to the other one of the two second axial guide rails 32.

An included angle is formed between the first moving direction and the second moving direction. Each one of the multiple second axial guide carriages 33 is mounted on one of the two second axial guide rails 32, and is capable of moving along the second moving direction relative to the corresponding second axial guide rail 32. In the present invention, the second axial moving device 30 has four second axial guide carriages 33. Two of the four second axial guide carriages 33 are mounted on one of the two second axial guide rails 32 and are spaced apart from one another. The other two of the four second axial guide carriages 33 are mounted on the other one of the two second axial guide rails 32 and are spaced apart from one another.

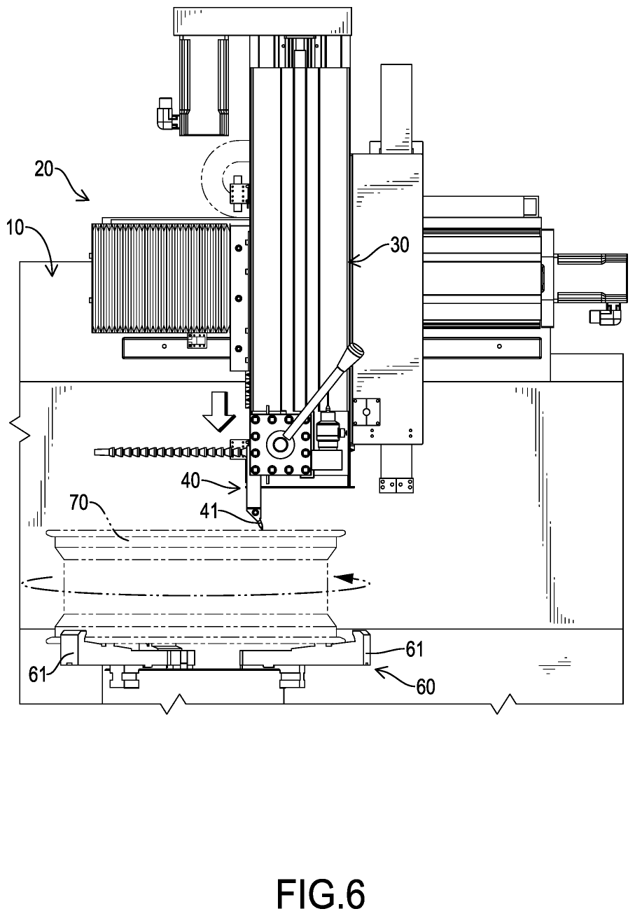

With reference to FIG. 3, the second axial threaded rod 35 is rotatably mounted between the two ends of the second axial slide table 31, is located between the two second axial guide rails 32, is parallel to the second moving direction, and is mounted through the second axial sliding stand 36. The second axial sliding stand 36 has a surface away from the first axial moving device 20, and the multiple second axial guide carriages 33 are mounted to the surface of the second axial sliding stand 36. The second axial actuator 34 is mounted on an inner side surface of the second axial slide table 31, and the second axial actuator 34 is spaced apart from and engages with the second axial threaded rod 35, such that the second axial actuator 34 actuates the second axial threaded rod 35 to rotate. Since how the second axial threaded rod 35 engages with the second axial actuator 34 is conventional in the art, details about the engagement will not be described. Driven by the second axial threaded rod 35, the second axial sliding stand 36 itself moves along the second moving direction and also drives the multiple second axial guide carriages 33 to move along the second moving direction relative to the corresponding second axial guide rail 32 as shown in FIGS. 3 and 6.

In the present invention, the second moving direction is a vertical direction, and the included angle formed between the first moving direction and the second moving direction is a right angle. Thus, the second axial sliding stand 36 and the multiple second axial guide carriages 33 move along the vertical direction.

With reference to FIGS. 1 and 3, the cutter turret 40 is mounted to a surface of the second axial moving device 30 away from the first axial moving device 20, and has a cutter 41 having a tip pointed downwardly.

With reference to FIGS. 1 and 2, the base 50 is spaced apart from the mounting rack 10, is on a side of the mounting rack 10 at which the first axial moving device 20 is located, and is located below the second axial moving device 30.

With reference to FIGS. 1 and 2, the chuck 60 is mounted on the base 50, and has multiple jaws 61 arranged annularly and disposed at spaced intervals. The multiple jaws 61 clamp a rim 70 as shown in FIG. 5, and each one of the multiple jaws 61 has a radius R as shown in FIG. 2. The cutter 41 of the cutter turret 40 is above the chuck 60, and is aligned to a position between two ends of one of the multiple jaws 61. The chuck 60 is electrically connected to a motor, such that the motor drives the chuck 60 to rotate. Since the base 50 is spaced apart from the mounting rack 10 rather than fixed on the mounting rack 10, a user can adjust a position of the chuck 60 relative to the cutter 41 by adjusting a distance between the base 50 and the mounting rack 10 according to practical need. Thus, the tip of the cutter 41 can point to different positions at the rim 70 as shown in FIG. 5 so as to trim the rim 70 at different positions. Furthermore, because the position of the chuck 60 relative to the cutter 41 can be adjusted, the rim trimming machine in accordance with the present invention can trim the rims 70 in variable radiuses.

With reference to FIG. 1, in the present invention, the rim trimming machine further has a housing 80. The mounting rack 10 is mounted to an inner side wall of the housing 80, and the base 50 is disposed on a bottom surface of the housing 80. The user can move the rim trimming machine to a client's place by simply transporting the housing 80 rather than the mounting rack 10 and the base 50 respectively. In other embodiments, the mounting rack 10 can be mounted to a mobile apparatus or vehicle such as a truck, and the base 50 can be disposed on the mobile apparatus or vehicle and be spaced apart from the mounting rack 10. In this way, the user can move the rim trimming machine to the client's place by moving the mobile apparatus or driving the truck.

To trim the rim 70, adjust the distance between the base 50 and the mounting rack 10 to make the tip of the cutter 41 aligned with a position at where the rim 70 is in need of trimming. Next, turn on the first axial actuator 24 to move the first axial sliding stand 26 to a position right above the position at where the rim 70 is in need of trimming along the first moving direction. Then turn on the second axial actuator 34 to make the second axial sliding stand 36 move to the position at where the rim 70 is in need of trimming along the second moving direction. At this time, the tip of the cutter 41 is in contact with the rim 70, so the rim trimming machine can start to trim the rim 70. With the aforementioned technical characteristics, the rim trimming machine has the following advantages.
1. Since the first axial moving device 20 is mounted to the mounting rack 10, which is a board, a weight of the present invention is lighter than that of the conventional rim trimming machine having the horizontal moving device 92 mounted on the heavy base 91, which is a block. Moreover, because the mounting rack 10 is vertically disposed, only a space capable of accommodating the base 50 needs to be spared. Compared with the conventional rim trimming machine that needs to spare a space capable of accommodating the base 91 with a large size, the present invention is space-saving. Being lighter and more space-saving than the conventional rim trimming machine, the present invention is more convenient to be moved to the client's place and the user can trim the rim 70 right at the client's place. Service quality is therefore raised.
2. In the present invention, the user can adjust the position of the chuck 60 relative to the cutter 41 by adjusting the distance between the base 50 and the mounting rack 10 according to practical need. Thus, the tip of the cutter 41 can point to different positions at the rim 70 so as to trim the rim 70 at different positions and trim the rims 70 in variable radiuses. Thus, practicality of the present invention is better than the conventional rim trimming machine.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rim trimming machine comprising:
a mounting rack being a board, disposed vertically, and having
a mounting surface forming an angle with a horizontal surface;
a first axial moving device mounted to the mounting surface of the mounting rack and having
a first axial sliding stand being movable along a first moving direction relative to the mounting rack;
a second axial moving device mounted to the first axial sliding stand of the first axial moving device and having
a second axial sliding stand being movable along a second moving direction relative to the first axial moving device;
a cutter turret mounted to a surface of the second axial moving device away from the first axial moving device and having
a cutter;
a base spaced apart from the mounting rack such that a distance between the base and the mounting rack is adjustable, and the base being on a side of the mounting rack at which the first axial moving device is located; and
a chuck mounted on the base and having
multiple jaws arranged annularly and disposed at spaced intervals, and each one of the multiple jaws having a radius;
wherein the cutter of the cutter turret is above the chuck, and is aligned to a position between two ends of one of the multiple jaws.

2. The rim trimming machine as claimed in claim 1, wherein the angle formed between the mounting surface and the horizontal surface is a right angle.

3. The rim trimming machine as claimed in claim 1, wherein an included angle is formed between the first moving direction and the second moving direction.

4. The rim trimming machine as claimed in claim 2, wherein an included angle is formed between the first moving direction and the second moving direction.

5. The rim trimming machine as claimed in claim 3, wherein the included angle formed between the first moving direction and the second moving direction is a right angle.

6. The rim trimming machine as claimed in claim 4, wherein the included angle formed between the first moving direction and the second moving direction is a right angle.

7. The rim trimming machine as claimed in claim 1, wherein
the rim trimming machine has a housing;
the mounting rack is mounted to an inner side wall of the housing; and
the base is disposed on a bottom surface of the housing.

8. The rim trimming machine as claimed in claim 2, wherein
the rim trimming machine has a housing;
the mounting rack is mounted to an inner side wall of the housing; and
the base is disposed on a bottom surface of the housing.

9. The rim trimming machine as claimed in claim 3, wherein
the rim trimming machine has a housing;
the mounting rack is mounted to an inner side wall of the housing; and
the base is disposed on a bottom surface of the housing.

10. The rim trimming machine as claimed in claim 4, wherein
the rim trimming machine has a housing;
the mounting rack is mounted to an inner side wall of the housing; and
the base is disposed on a bottom surface of the housing.

11. The rim trimming machine as claimed in claim 5, wherein
the rim trimming machine has a housing;
the mounting rack is mounted to an inner side wall of the housing; and
the base is disposed on a bottom surface of the housing.

12. The rim trimming machine as claimed in claim 6, wherein
the rim trimming machine has a housing;
the mounting rack is mounted to an inner side wall of the housing; and
the base is disposed on a bottom surface of the housing.
